(19) United States
(12) Patent Application Publication
(10) Pub. No.: US 2014/0260733 A1
(43) Pub. Date: Sep. 18, 2014

(54) SYSTEMS AND METHODS FOR ELECTRIC CONTROLLED REACH CARRIAGE

(71) Applicant: Fernando D. Goncalves, Binghamton, NY (US)

(72) Inventor: Fernando D. Goncalves, Binghamton, NY (US)

(21) Appl. No.: 13/837,084

(22) Filed: Mar. 15, 2013

(51) Int. Cl. F16H 25/12

(52) U.S. Cl. CPC F16H 25/12
USPC 74/89.38; 74/89

(57) ABSTRACT

An electric actuator replaces the hydraulic reach actuator in a reach carriage for a reach truck. The electric actuator may be a linear actuator and may have a rotary motor and a combination ball screw and ball assembly for converting the rotary motion of the motor into linear motion to extend and retract a rod. A force limiter can be disposed between the motor and the ball screw, and may be coupled to the motor and the ball screw. The force limiter prevents a contact force on the rod from damaging the motor. The force limiter allows the reach carriage to operate normally until a contact force occurs, then disengages if a threshold level of force is exceeded. The force limiter may be a torque limiter that automatically reengages after the contact force has attenuated.

### CROSS-REFERENCE TO RELATED APPLICATIONS

Not applicable.

### STATEMENT CONCERNING FEDERALLY SPONSORED RESEARCH OR DEVELOPMENT

Not applicable.

### FIELD OF THE INVENTION

The invention relates to the field of vehicles having extending reach carriages, and more specifically to driving the extension arm of a reach carriage with an electric actuator that is protected against back-driving contact force.

### BACKGROUND OF THE INVENTION

Lift trucks, also known as forklifts, are commonly used to raise and position heavy loads on elevated surfaces. Some lift trucks include a reach carriage that extends horizontally away from the base or operating unit of the lift truck to “reach” a position that is at or within the reach carriage's limit of extension. Such lift trucks are referred to herein as “reach trucks.” A reach truck's reach carriage may be extended in various ways according to different models of a reach truck. In some models, the reach carriage is attached to the mast of the reach truck, and the mast extends away from and retracts toward the operating unit. The operator operates one or more hydraulic actuators to move the mast and reach carriage. In other modes, the reach carriage includes a pantographic extension arm connected between the mast and the fork assembly. Extension and retraction of the extension arm is conducted using a hydraulic ram cylinder attached between the mast and a pivot point of the extension arm. The extension arm extends as the cylinder fills with fluid, and retracts as the cylinder empties.

In an effort to increase productivity, reach truck operators conduct their reach trucks in a very fluid manner, one operation seamlessly flowing into the next. An example of such a maneuver is the pallet scoop, in which an operator will approach a pallet with the reach carriage extended and, without stopping, engage and lift the pallet. The reach carriage essentially contacts with the pallet, imparting a contact force upon the extension arm and cylinder that can damage or reduce the life of the cylinder and other components. Typically, hydraulic cylinders are fitted with bypass valves that open when the pressure, such as excessive pressure imparted by the contact force, exceeds a certain threshold. This allows the extension arm to collapse to a retracted position without damaging the cylinder or the extension arm.

Like all hydraulic actuators, hydraulic reach actuators are subject to inefficiencies. For example, hydraulic actuation requires a pump to pressurize and depressurize the cylinder, and fluid hoses to transfer hydraulic fluid between the pump and cylinder. The pump draws current and takes up space in the reach truck, which is desirably compact. The hoses must be routed between the components, and the route must consider that the reach carriage may have a vertical range of several meters. Hoses are typically routed over the reach truck's mast, adding hose length and orientation variations that may reduce hydraulic efficiency.

Hydraulic efficiency advantages can be achieved by replacing the hydraulic actuators on a reach carriage with electric actuators. It would therefore be desirable to have an electric reach actuator that incorporates an electric actuator having a force limiter to operate the reach carriage.

### SUMMARY OF THE INVENTION

The invention overcomes the drawbacks of the previous reach carriage actuators by eliminating the need for a hydraulic pump, cylinder and hydraulic hoses.

A typical linear electric actuator is configured to resist back-driving of the actuator. That is, the motor rotates gears to extend the actuator, and the motor essentially locks into place so that it will not spin in the opposite direction to retract the actuator, such as in response to a contact force on the actuator. This design is favorable for use in a reach carriage under normal conditions, but in a maneuver such as the pallet scoop, the actuator or other components may be damaged due to the intrinsic resistance to back-driving. A linear actuator that includes a force limiter can be used.

The invention provides an electric actuator for driving the extension arm of a reach carriage. The electric actuator is equipped with a force limiter that relieves back-driving force on the electric actuator before the actuator is damaged, allowing the extension arm to collapse in reaction to a contact. The force limiter may automatically re-engage the actuator after the excessive force has attenuated.

In one embodiment, a reach actuator for a reach carriage having a carriage frame and a pantographic extension arm comprises: a housing attached to the carriage frame; a rod extending from the housing and attached to the extension arm; a rotary motor configured to drive the rod; and a force limiter disposed between the rotary motor and the rod and configured to disengage if a force applied to the rod exceeds a predetermined threshold.

In another embodiment of a reach carriage having a carriage frame and a pantographic extension arm attached to the carriage frame, the improvement comprises an electric actuator attached to the carriage frame and the extension arm and configured to extend and retract the extension arm, the electric actuator comprising: a housing attached to the carriage frame; a ball screw disposed in the housing; a ball assembly movably attached to the ball screw; a rod attached to the ball assembly and the extension arm; a force limiter attached to the ball screw; and a rotary motor attached to the force limiter.

To the accomplishment of the foregoing and related ends, the embodiments, then, comprise the features hereinafter fully described. The following description and the annexed drawings set forth in detail certain illustrative aspects of the invention. However, these aspects are indicative of but a few of the various ways in which the principles of the invention can be employed. Other aspects, advantages and novel features of the invention will become apparent from the following detailed description of the invention when considered in conjunction with the drawings.

### BRIEF DESCRIPTION OF THE DRAWINGS

The embodiments will hereafter be described with reference to the accompanying drawings, wherein like reference numerals denote like elements, and:

FIG. 1 is a left side view of a reach truck in accordance with this disclosure;

FIG. 2 is a top right rear perspective view of an extension arm, showing the connection between the carriage frame and the extension arm and further showing a hydraulic cylinder;

FIG. 3 is a top left rear perspective view of an extension arm, showing the connection between the carriage frame and the extension arm and further showing an electric actuator in accordance with this disclosure;

FIG. 4 is a partial cutaway perspective view of an embodiment of an electric actuator in accordance with this disclosure;

FIG. 5 is an exploded view of another embodiment of an electric actuator in accordance with this disclosure;

FIG. 6 is an exploded view of a force limiter in accordance with this disclosure; and

FIG. 7 is a top left rear perspective view of an extension arm, showing the connection between the carriage frame and the extension arm and further showing the electric actuator of FIG. 5, in accordance with this disclosure.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE PREFERRED EMBODIMENTS

The invention will now be described more specifically with reference to the following embodiments. It is to be noted that the following descriptions of preferred embodiments are presented herein for purpose of illustration and description only. It is not intended to be exhaustive or to be limited to the precise form disclosed.

It is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

Unless specified or limited otherwise, the terms “connected” and “coupled” and variations thereof are used broadly and encompass both direct and indirect mountings, connections, supports, and couplings. Further, “connected” and “coupled” are not restricted to physical or mechanical connections or couplings. As used herein, unless expressly stated otherwise, “connected” means that one element/feature is directly or indirectly connected to another element/feature, and not necessarily electrically or mechanically. Likewise, unless expressly stated otherwise, “coupled” means that one element/feature is directly or indirectly coupled to another element/feature, and not necessarily electrically or mechanically. Thus, although schematics shown in the figures depict example arrangements of processing elements, additional intervening elements, devices, features, or components may be present in an actual embodiment.

The various embodiments of the invention will be described in connection with systems and methods for electrical actuation of a reach carriage for a reach truck. That is because the features and advantages of the invention are well suited for this purpose. Still, it should be appreciated that the various aspects of the invention can be applied to other vehicles and in other industries and processes capable of utilizing an extending arm, particularly a pantograph.

Referring now to the Figures, and more particularly to FIG. 1, the general arrangement of a representative vehicle, such as a reach truck 20, incorporating a reach carriage 24 is shown. For simplicity, the detailed description will describe the embodiments associated with the reach truck 20 incorporating the reach carriage 24. It is to be appreciated that the details of the invention may also be beneficial and adapted for a wide variety of devices and vehicles, including a reach truck where the reach carriage is coupled to a mast 22, and the mast is configured to extend and retract. Other known extension mechanisms are contemplated, including drive systems, rails, slides, glides, gears, cables, and the like. Although the reach truck 20, by way of example, is shown as a standing configuration lift truck, it will be apparent to those of skill in the art that the features of the invention are not limited to vehicles of this type, and can also be provided in various other types of vehicles, including but not limited to, other material handling and lift vehicle configurations.

As seen, one embodiment of the reach truck 20 includes an operating unit 21 that may serve as a weighted base for the reach truck 20 and also provides controls to an operator for moving reach truck 20 and operating the reach carriage 24. The reach truck 20 includes a vertically oriented mast 22 mounted relative to the operating unit 21. The reach carriage 24 includes an extension arm 25 that connects the mast 22 to a lift assembly 23, which may comprise one or more forks 26. The extension arm 25 is illustrated as a double pantographic arm but may be a single pantographic arm (see FIG. 3), or more than a double pantographic arm. The extension arm 25 can extend and retract in other fashions, such as by telescopic operation. Manipulation of the controls by the operator may cause various motors, wheels, cables, pneumatic or hydraulic pistons, and other mechanical components to raise and lower the reach carriage 24 along the mast 22, and to extend and retract the extension arm 25 with respect to the mast 22.

Referring to FIGS. 2 and 3, the extension arm 25 may include a plurality of pivotably interconnected rigid members, referred to herein as studs 30. A stud 30 may connect to one or more adjacent studs 30 at a midpoint or an endpoint of each stud 30, at one or both sides of the extension arm 25, to create a pantograph as is known in the art. A pivot 35 is formed at each attachment point between studs 30. The extension arm 25 pivotably attaches to a carriage frame 28 of the reach assembly 24. In some embodiments, the carriage frame 28 can movably attach to and translate vertically along the mast 22. The extension arm 25 attaches to the carriage frame 28 at a stationary pivot 39 at the top of the extension arm 25 and a translating pivot 40 at the bottom of the extension arm 25. The stud or studs 30 attaching at the translating pivot 40 may be attached to a wheel 45 disposed within a vertical channel 50 on the carriage frame 28. The wheel 45 moves vertically up the channel 50 to extend the extension arm 25 and down the channel 50 to retract the extension arm 25 according to pantographic motion. The top 51 of the channel defines the extension limit of the extension arm 25 and the bottom 52 of the channel defines the retraction limit, provided the reach truck 20 does not include a bumper or another structure for stopping extension and/or retraction.

In existing systems, the motion of the extension arm 25 is mechanically controlled with at least one hydraulic ram cylinder 55. The cylinder 55 attaches at a proximal end to the carriage frame 28 and at a distal end to an axle 34 attached between the studs 30 that are attached to the carriage frame 28 at the stationary pivot 39. The cylinder 55 may be attached at one or both ends with a clevis fastener. The cylinder 55 may be attached to a fluid supply hose (not shown) connected to a hydraulic pump (not shown) that fills and empties the cylinder 55 to create the pressure differentials that operate the ram 56 of the cylinder 55 to extend or retract the extension arm 25, as is known in the art.

Referring to FIG. 3, in one embodiment the cylinder 55 may be directly replaced by an electric actuator 60. That is, the electric actuator 60 may be attached between the attachment mechanisms that held the cylinder 55, and attached to a power supply (not shown) and control unit (not shown). The electric actuator 60 may be a linear actuator having a rod 61 that attaches at its distal end to the axle 70, such as with a clevis fastener. The rod 61 projects from a housing 62 that may be attached to the carriage frame 28 with a clevis fastener. In operation, the rod 61 is driven out of the housing 62 to extend the extension arm 25 in pantographic motion. The electric actuator 60 may be any electro-mechanical actuator capable of moving a load, and in some applications on the order of several tons, in a reach carriage. Suitable actuators include, without limitation, linear actuators with either a parallel-offset rotary motor, see FIG. 4, or an inline rotary motor. See FIG. 5.

FIG. 4 illustrates a suitable electric actuator 60, although other linear actuators are contemplated. The housing 62 contains a rotary motor 65 configured to drive a gear assembly 66 that, in turn, rotates a ball screw 75. The ball screw 75 converts the rotary motion into linear motion by translating a ball assembly 76 linearly along the length of the ball screw 75 as is known in the art. The ball assembly 76 is attached to the distal end of the rod 61 and extends and retracts the rod 61 with respect to the housing 62. Preferably, the electric actuator 60 is highly geared, which permits its use with large loads but prevents the rotary motor 65 from being back-driven by a contact force.

Referring to FIG. 5, in some embodiments, an electric actuator 78 may include a force limiter 80 that prevents damage to the electric actuator 78 by the contact force by disengaging, or “slipping,” when a threshold force is exceeded. The force limiter 80 may be disposed between the rotary motor 65 and the ball screw 75 or other component for converting rotary motion into linear motion. The force limiter 80 may be connected in series with the rotary motor 65 and the ball screw 75, and preferably couples the rotary motor 65 to the ball screw 75. The force limiter 80 may be coaxial with both the rotary motor 65 and the ball screw 75, and may further be coaxial with one or both of the rod 61 and the housing 62. When the force limiter 80 disengages, the extension arm 25 may collapse toward its retracted position. Once the contact force has been reduced to below the threshold, the force limiter 80 may be reengaged and normal operation of the reach carriage 24 may resume. The force limiter 80 may be manually reengaged by the operator, but preferably the force limiter 80 automatically reengages.

The force limiter 80 may be any limiter device that responds to an excessive force by automatically disengaging when the force exceeds a threshold. Suitable force limiters 80 include a torque limiter, a friction clutch, a permanent magnet or electromagnet disconnect, a shear pin, or a passive or semi-active disengaging shock absorber. Referring to FIG. 6, in one embodiment the force limiter 80 may be a ball-detent torque limiter. The torque limiter has a first gear 85 that cooperates with the rotary motor 65. A detent ring 90 may be affixed to or integral with the first gear 85. The detent ring 90 comprises a series of detents of substantially uniform width and height. Each detent has a peak, such that a valley is formed between adjacent detents. A torque plate 95 may be disposed adjacent the detent ring 90, and may touch the peaks of the detents when the torque limiter is assembled. One or more bearing holes 100 are disposed through the torque plate 95, each to retain a ball bearing 105. The torque plate 95 may further comprise a spindle 110 upon which a spring plate 115 is positioned. A spring 120 may be biased between the spring plate 115 and a second gear 125, which is attached to the end of the spindle 110. The second gear cooperates with the ball screw 75. The first gear 85, torque plate 95, spindle 110, spring plate 115, spring 120, and second gear 125 can all be coaxial with the rotary motor 65 or its gear assembly 66, and with the ball screw 75.

The spring 120 holds the spring plate 115 under tension against the torque plate 95, forcing each ball bearing 105 into a valley between detents in the detent ring 90. With the ball bearings 105 thus secured, the entire torque limiter rotates with the rotary motor 65, in turn rotating the ball screw 75 to actuate the rod 61. When the rod 61 is in an extended position, a contact force that drives the rod 61 back into the housing will attempt to rotate the ball screw 75, force limiter 80, and rotary motor 65 in the opposite direction, but the rotary motor 65 will resist. This resistance causes torque between the first gear 85 and the torque plate 95, which pushes the ball bearings 105 against the spring plate 115 as the ball bearings 105 attempt to roll over the peak of the adjacent detent. If the torque is high enough, the ball bearings 105 will overcome the biasing force of the spring 120 and slip over the detent, disengaging the torque limiter. Specifically, this allows the torque plate 95 and second gear 125 to rotate in the opposite direction as the rod 61 is pushed back into the housing 62, and the extension arm 25 collapses toward its retracted position. As the contact force attenuates, the spring 120 forces the ball bearings 105 back into a valley in the detent ring 90 and the torque limiter automatically reengages and normal operation of the reach carriage may resume.

Referring to FIG. 7, the hydraulic cylinder 55 may be replaced by the electric actuator 78 of FIG. 5, which includes a force limiter 80 and a rotary motor 65 that are each coaxial with the rod 61. The electric actuator 78 may be attached to the reach carriage 28 and the axle 70 of the extension arm 25 as described with respect to FIG. 3. In still other embodiments, the electric actuator 78 may be attached between the operating unit 21 and the mast 22, or between other structures of the reach truck 20 such that actuation of the electric actuator 78 extends and retracts the reach carriage 24.

Preferred embodiments have been described in considerable detail. Many modifications and variations to the preferred embodiment described will be apparent to a person of ordinary skill in the art. Therefore, the invention should not be limited to the embodiments described.

Finally, it is expressly contemplated that any of the processes or steps described herein may be combined, eliminated, or reordered. Accordingly, this description is meant to be taken only by way of example, and not to otherwise limit the scope of this invention.

We claim:

1. A reach actuator for a reach carriage, the reach actuator comprising:
a housing;
a rod extending from the housing, the rod being attached to the reach carriage so as to extend and retract the reach carriage as the rod is driven;
a rotary motor configured to drive the rod; and
a force limiter disposed between the rotary motor and the rod and configured to disengage if a force applied to the rod exceeds a predetermined threshold.

2. The reach actuator according to claim 1:
wherein the reach carriage has a carriage frame and an extension arm;
wherein the housing is attached to the carriage frame; and
wherein the rod is attached to the extension arm.

3. The reach actuator according to claim 2:
wherein the force limiter is coaxial with the rod.

4. The reach actuator according to claim 3:
wherein the force limiter is further coaxial with the rotary motor.

5. The reach actuator according to claim 2:
further comprising:
a ball screw disposed in the housing coaxially with the rod; and
a ball assembly movably attached to the ball screw and the rod such that the ball assembly extends and retracts the rod with respect to the housing when the ball screw is rotated;
wherein the rotary motor drives the rod by rotating the ball screw.

6. The reach actuator according to claim 5:
wherein the force limiter is coupled to the rotary motor and to the ball screw.

7. The reach actuator according to claim 6:
wherein the force limiter is coaxial with the rotary motor and the ball screw.

8. The reach actuator according to claim 2:
wherein the force limiter is a torque limiter.

9. The reach actuator according to claim 2:
wherein the force limiter is configured to automatically reengage after the force attenuates to below the predetermined threshold.

10. The reach actuator according to claim 9:
wherein the force limiter is a ball-detent torque limiter.

11. The reach actuator according to claim 2:
wherein, when the force limiter disengages, the rod retracts toward the housing until the rod is fully retracted or the force limiter reengages.

12. The reach actuator according to claim 11:
wherein the extension arm collapses toward a retracted position while the force limiter is disengaged.

13. The reach actuator according to claim 1:
wherein the force limiter is a torque limiter.

14. The reach actuator according to claim 1:
wherein the force limiter is coaxial with the rotary motor and with the rod.

15. The reach actuator according to claim 1:
wherein the extension arm is a pantographic extension arm.

16. A reach carriage having a carriage frame and a pantographic extension arm attached to the carriage frame, the improvement comprising an electric actuator attached to the carriage frame and the extension arm and configured to extend and retract the extension arm, the electric actuator comprising:
a housing attached to the carriage frame;
a ball screw disposed in the housing;
a ball assembly movably attached to the ball screw;
a rod attached to the ball assembly and the extension arm;
a force limiter attached to the ball screw; and
a rotary motor attached to the force limiter.

17. The reach carriage according to claim 16:
wherein the housing, ball screw, rod, force limiter, and rotary motor are coaxial.

18. The reach carriage according to claim 16:
wherein the electric actuator is configured to allow the extension arm to collapse toward a retracted position in response to a back-driving contact force.

19. The reach carriage according to claim 16:
wherein the rotary motor turns the ball screw to move the ball assembly along the ball screw, the movement of the ball assembly extending and retracting the rod with respect to the housing; and
wherein the force limiter disengages if a force applied to the rod exceeds a predetermined threshold, the disengagement preventing the rotary motor from turning the ball screw.

20. The reach carriage according to claim 19:
wherein the force limiter automatically reengages after the force attenuates to below the predetermined threshold.

21. The reach carriage according to claim 20:
wherein the force limiter is a ball-detent torque limiter.
